(19) United States
(12) Patent Application Publication
(10) Pub. No.: US 2019/0001743 A1
(43) Pub. Date: Jan. 3, 2019

(54) DOUBLE-SURFACED VISUALIZATION GLASS PHOTOGRAPH AND METHOD FOR MANUFACTURING SAME

(71) Applicant: HON HAI PRECISION INDUSTRY CO., LTD., New Taipei (TW)

(72) Inventors: CHEN-CHU CHIANG, New Taipei (TW); HAN-LUNG CHAO, New Taipei (TW); HAN-LUNG LEE, New Taipei (TW); HUNG-LIEN YEH, New Taipei (TW); CHIH-JUNG CHANG, New Taipei (TW); JIH-CHEN LIU, New Taipei (TW); FENG-YUEN DAI, New Taipei (TW); HUNG-CHUN MA, New Taipei (TW)

(21) Appl. No.: 15/686,171

(22) Filed: Aug. 25, 2017

(30) Foreign Application Priority Data
Jun. 30, 2017 (TW) 106122150

(51) Int. Cl. B44F 11/00; B32B 17/06; B32B 37/12; B29C 64/112; B33Y 80/00; B33Y 70/00; G09F 19/12; G09F 7/00; B44F 7/00; B44F 9/12

(52) U.S. Cl. CPC B44F 11/00; B32B 17/065; B32B 37/1292; B29C 64/112; B33Y 80/00; B29K 2033/04; G09F 19/12; G09F 7/00; B44F 7/00; B44F 9/12; B32B 2451/00; B33Y 70/00

(57) ABSTRACT

A glass-mounted image, proof against the effects of oxidation, which can be viewed with different effects from the front or from the rear includes a transparent base and a pattern layer. The transparent base includes a front surface and a rear surface and the pattern layer is formed on the rear surface. The pattern layer is formed by inkjet printing UV-curable ink and curing the ink and the pattern layer is a fogged surface in contrast with the opposing smooth and polished appearance seen through the glass from the other side.

### FIELD

The subject matter herein generally relates to ornamental photo display, in particular to double-surfaced visualization glass photograph and method for manufacturing same.

### BACKGROUND

A method for manufacturing a double-surfaced visualization glass photograph comprises steps of providing a glass; coating thereon a layer of adhesive, and adhering a paper-based photograph on the glass by the layer of adhesive. However, the adhesive layer inside the glass photograph is easily oxidized in the air and becomes yellow, thereby reducing the ornamental quality.

### BRIEF DESCRIPTION OF THE DRAWINGS

Implementations of the present technology will now be described, by way of example only, with reference to the attached figures.

FIG. 1 is an orthographic presentation of a double-surfaced visualization glass photograph in accordance with a first exemplary embodiment.

FIG. 2 is a rear elevation of the double-surfaced visualization glass photograph of FIG. 1.

FIG. 3 is a cross-sectional view of the double-surfaced visualization glass photograph of FIG. 1.

FIG. 4 is a cross-sectional view of a second exemplary embodiment of a double-surfaced visualization glass photograph.

FIG. 5 is a cross-sectional view of a third exemplary embodiment of a double-surfaced visualization glass photograph.

FIG. 6 is a flowchart of a method for manufacturing the double-surfaced visualization glass photograph of FIG. 4.

FIG. 7 is a cross-sectional view of a UV inkjet printer used in manufacturing the double-surfaced visualization glass photograph.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

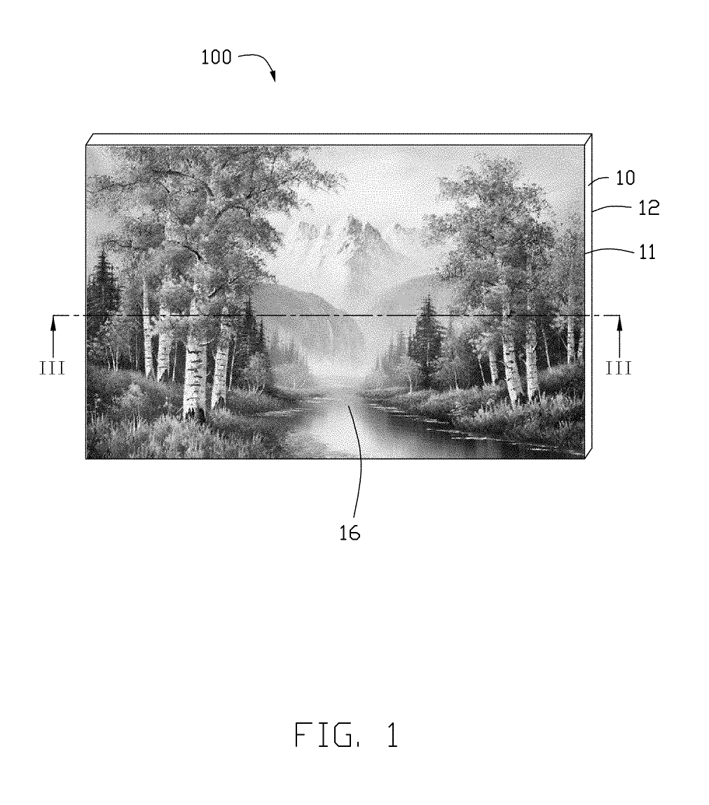

FIGS. 1-3 illustrate a double-surfaced visualization glass photograph 100 according to an exemplary embodiment. The double-surfaced visualization glass photograph 100 includes a transparent base 10, a bonding layer 14, a pattern layer 16, and a hard coating layer 18. The term “glass-mounted photograph” includes any finished design or pattern resembling an actual photograph.

The transparent base 10 is reinforced glass or acrylic material. Reinforced glass is not easily broken. Acrylic material has advantages of light weight, high transparency, and easy machining. The transparent base 10 can be a simple shape, such as prismatic shape, spherical shape, or cylindrical shape, and also can be a complicated shape, such as that of the human form, animal shape, flower shape, or bird shape. The transparent base 10 includes a front surface 11 and a rear surface 12 opposite to the front surface 11. In an alternative embodiment, the front surface 11 is a polished and smooth surface, and the rear surface 12 is a rough or matte surface.

The bonding layer 14 is formed on the rear surface 12. The bonding layer 14 is configured to increase adhesion between the pattern layer 16 with the transparent base 10, to prevent the pattern layer 16 from falling off the transparent base 10. The bonding layer 14 is made of transparent and colorless material, such as ultraviolet-curable glue (UV glue). A thickness range of the bonding layer 14 is about 5 micrometers to about 50 micrometers, preferably is about 5 micrometers.

The pattern layer 16 is formed on the bonding layer 14. A thickness range of the pattern layer 16 is from about 5 micrometers to about 50 micrometers. The pattern layer 16 is a photograph or facsimile of a photograph and is formed by spraying ultraviolet-curable ink (UV ink) on the surface of the bonding layer 14, and curing the UV ink on the surface of the bonding layer 14. That is, the pattern layer 16 is a UV ink layer.

An ink-jet printer is used to jet print UV ink on the bonding layer 14 to form the pattern layer 16, thus, the pattern layer 16 includes a plurality of micro protrusions and micro concavities, and thus form a fogged surface. The pattern layer 16 can be a portrait, a landscape scene, an animal picture, auspicious image, graining pattern, leather pattern, or 3D image. Colors of the pattern layer 16 can be single color or color combinations. In this exemplary embodiment, the pattern layer 16 is a 2D image, covering all of the bonding layer 14.

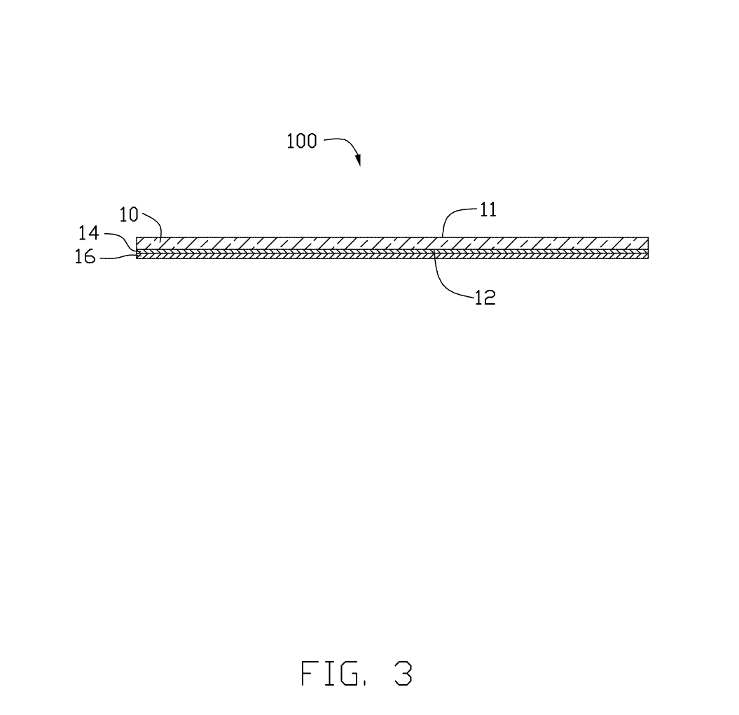

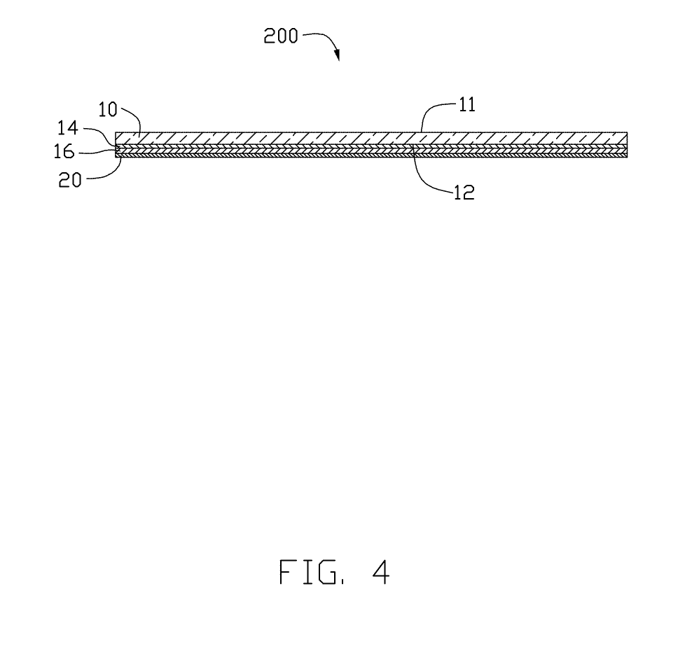

FIG. 4 illustrates a double-surfaced visualization glass photograph 200 according to a second exemplary embodiment. The photograph 200 is similar to the photograph 100 in FIG. 3. The difference between the photograph 200 and the photograph 100 in FIG. 3 is that the photograph 100 further includes a hard coating layer 20. The hard coating layer 20 is formed on the pattern layer 16.

The hard coating layer 20 is transparent and colorless and configured to protect the pattern layer 16 against scratches. The hard coating layer 20 can be made of rigid resin, such as acrylic glass or polymethylmethacrylate (PMMA). A thickness range of the hard coating layer 20 is about 5 micrometers to about 50 micrometers, preferably is about 10 micrometers.

In this exemplary embodiment, the hard coating layer 20 is composed of acrylic, titanium dioxide, and additives. The hard coating layer 20 is mixed at certain proportions under room temperature, and the hard coating layer 20 enhances surface atomization. In a preferred exemplary embodiment, the additives comprise a dispersing agent, defoaming agent, photosensitizer, and light stabilizer, and the weight ratio proportions of the acrylic, titanium dioxide, and antioxidant are respectively about 65%˜75%, 15˜20%, and 5˜15%.

The pattern layer 16 in the double-surfaced visualization glass photograph 100 is formed by spraying UV ink on the bonding layer 14 and protecting same by the hard coating layer 18, thereby the pattern layer 16 has an advantage of permanent preservation and never turning yellow.

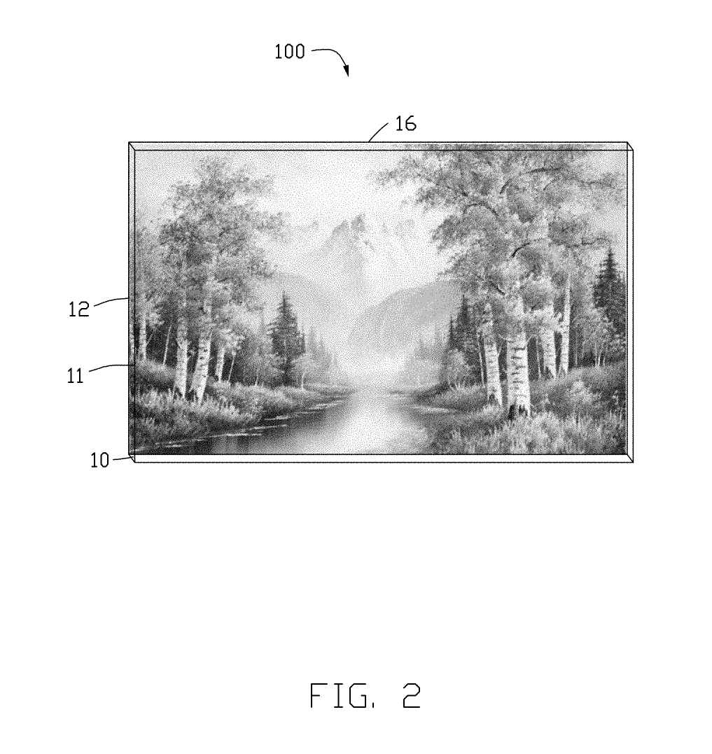

Because the hard coating layer 20 is colorless and transparent, and the pattern layer 16 is formed on the transparent base 10, the double-surfaced visualization glass photograph 100 can be viewed from the front, as shown in FIG. 1, and also can be viewed from the rear, as shown in FIG. 2. From the front side, a polished and reflective surface is seen, and from the rear side, a matte or fogged surface is seen.

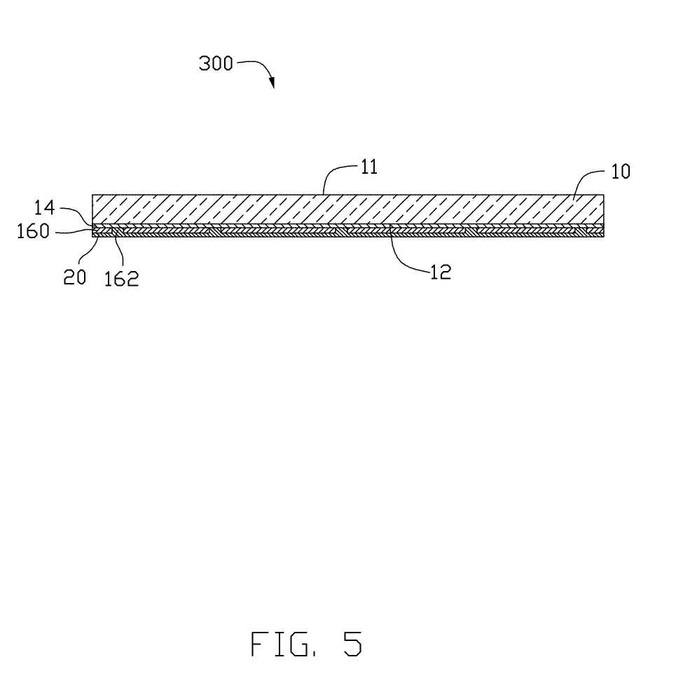

FIG. 5 illustrates a double-surfaced visualization glass photograph 300 according to a second exemplary embodiment. The photograph 300 is similar to the photograph 100 in FIG. 3. The difference between the photograph 300 and the photograph 100 in FIG. 3 is that the pattern layer 160 in double-surfaced visualization glass photograph 300 is a 3D image, and defines a plurality of pattern gaps 162 therein. The hard coating layer 20 is infilled into the pattern gaps 162.

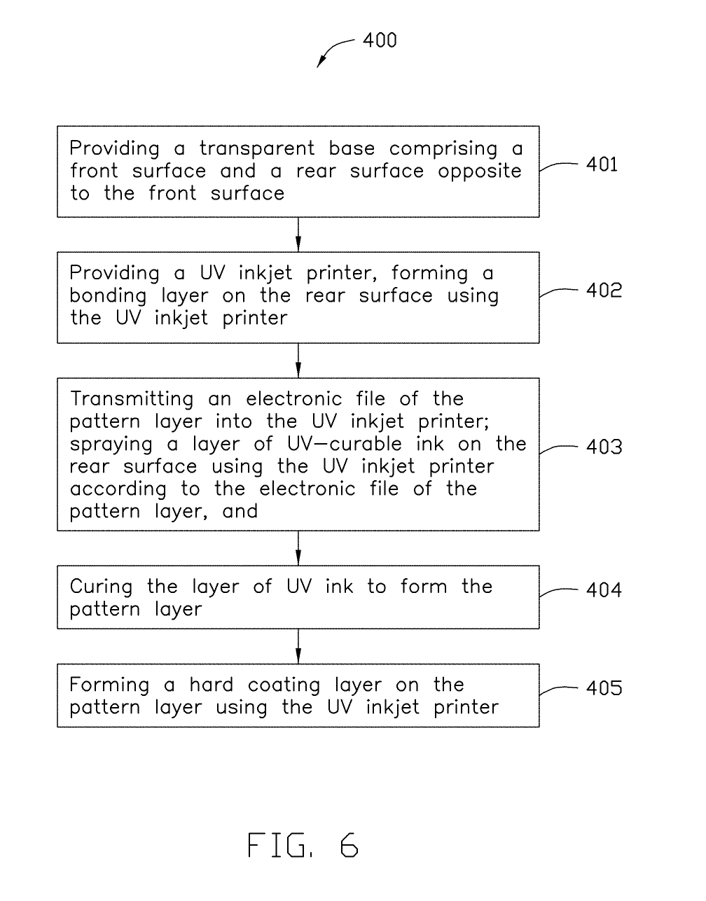

FIG. 6 illustrates a flowchart in accordance with a third exemplary embodiment. The example method 400 for manufacturing the double-surfaced visualization glass photograph 200 (shown in FIG. 4) is provided by way of an example, as there are a variety of ways to carry out the method. Additionally, the illustrated order of blocks is by example only and the order of the blocks can change or be omitted. The method 400 can begin at block 401.

At block 401, a transparent base 10 is provided, the transparent base 10 includes a front surface 11 and a rear surface 12 opposite to the front surface 11, and the rear surface is cleaned. The transparent base 10 is made from reinforced glass or acrylic material. Reinforced glass is not easily broken. Acrylic material has advantages of light weight, high transparency, and easy machining.

The rear surface 12 is processed to form a hardened coating layer (not shown) there on. A hardness of the transparent base 10 can reach up to about 5˜6 H, which can improve wear scratch resistant, transparency, and has a good finish.

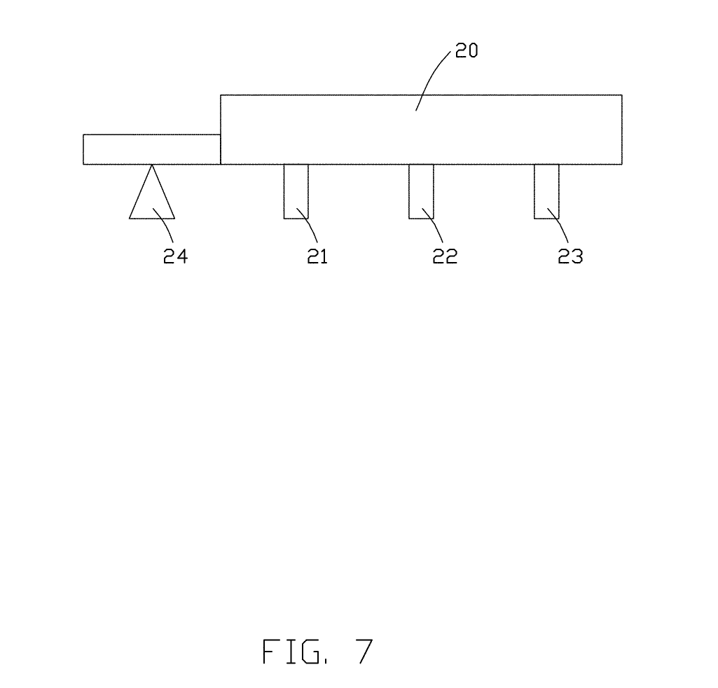

At block 402, a UV inkjet printer 20 is provided, as shown in FIG. 7, and a bonding layer 14 is formed on the rear surface using the UV inkjet printer 20, as shown in FIG. 5, the UV inkjet printer 20 includes a first spraying nozzle 21, a second spraying nozzle 22, a third spraying nozzle 23 and a UV source 24 mounted at one side on the UV inkjet printer 20. The first spraying nozzle 21, the second spraying nozzle 22, and the third spraying nozzle 23 are connected to different cartridges through pipelines. The bonding layer 14 is made from UV (ultraviolet) glue. Spray a layer of UV glue on the rear surface 12 to form the bonding layer 14 using the first spraying nozzle 21. The bonding layer 14 is configured to increase a contact force between the pattern layer 16 with the transparent base 10, to prevent the pattern layer 16 from falling off the transparent base 10.

At block 403, an electronic file (not shown) of the pattern layer 16 is transmitted into the

UV inkjet printer 20, a layer of UV ink is printed on the bonding layer 14 using the second spraying nozzle 22 according to the electronic file of the pattern layer 16, and cured by a UV light emitted from the UV source 24. Thereby, the pattern layer 16 is adhered on the transparent base 10 firmly by the bonding layer 14.

The electronic file of the pattern layer 16 is transmitted into the UV inkjet printer using blue tooth transmission, Wi-Fi transmission or USB transmission or other types of data transmission but not limited to the examples provided herein . The UV inkjet printer 20 prints an layer of ink on the bonding layer 14 to form the pattern layer 16 according to the electronic file. Colors of the pattern layer 16 can be single color or color combinations. The pattern layer 16 can be a portrait, landscape, animal, auspicious pattern, graining pattern, leather pattern, or 3D image.

At block 404, the UV source 24 is applied to cure the UV ink on the bonding layer 14, and a curing time is about 3-5 seconds, and then, the ink is firmly adhered on the transparent base and formed the pattern layer 16.

At block 405, a hard coating layer 18 is printed on the pattern layer 16 by the third spray nozzle 23, thereby, the double-surfaced visualization glass photograph 100 is obtained. The hard coating layer 18 is configured to prevent the pattern layer 16 from scratches. The coating layer 18 can be made of rigid resin, such as acrylic glass or polymethylmethacrylate (PMMA). A thickness range of the coating layer 18 is about 5 micrometers to about 50 micrometers, is preferably, about 10 micrometers.

In this exemplary embodiment, the hard coating layer 18 is composed of acrylic, titanium dioxide and additives and is mixed at a certain proportion under room temperature. In a preferred exemplary embodiment, the proportion is the weight ratio of the acrylic, titanium dioxide, and antioxidant, and the weight ratio are respectively about 65%˜75%, 15˜20%, 5˜15%.

The exemplary embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. A double-surfaced visualization glass photograph, comprising:
a transparent base comprising a front surface and a rear surface opposite to the front surface; and a pattern layer formed on the rear surface, and the pattern layer being formed by jet printing UV-curable ink and curing the UV-curable ink using an inkjet printer, and the pattern layer is a fogged surface.

2. The double-surfaced visualization glass photograph of claim 1, wherein the front surface is a polished surface, and the rear surface is a matted surface.

3. The double-surfaced visualization glass photograph of claim 2, wherein the photograph further comprises a transparent bonding layer formed on the rear surface, and the pattern layer formed on the transparent bonding layer.

4. The double-surfaced visualization glass photograph of claim 1, further comprising a hard coating layer formed on the printing pattern layer, and the hard coating layer is colorless and transparent.

5. The double-surfaced visualization glass photograph of claim 3, wherein the transparent bonding layer is formed by spraying UV-curable glue or heat-curable glue on the transparent base.

6. The double-surfaced visualization glass photograph of claim 5, wherein the pattern layer is a 3D image and defines a plurality of pattern gaps therein, and the coating layer is filled into the pattern gaps.

7. The double-surfaced visualization glass photograph of claim 3, wherein the coating layer is made of acrylic, titanium dioxide and additives, the coating layer is mixed at a predetermined proportion under room temperature.

8. The double-surfaced visualization glass photograph of claim 6, wherein the additive comprises a dispersing agent, a defoaming agent, a photosensitizer and a light stabilizer.

9. The double-surfaced visualization glass photograph of claim 6, wherein the predetermined proportion is a weight ratio of the acrylic, titanium dioxide, and additives, and the weight ratio between the acrylic, titanium dioxide, and additive is about 65%˜75%, 15˜20%, 5˜15%, respectively.

10. The double-surfaced visualization glass photograph of claim 6, wherein a thickness of the transparent bonding layer is in a range between about 5˜10 um.

11. The double-surfaced visualization glass photograph of claim 6, wherein the transparent base is made from reinforced glass or acrylic material.

12. A method for manufacturing a double-surfaced visualization glass photograph, comprising:
providing a transparent base comprising a front surface and a rear surface opposite to the front surface;
providing a UV inkjet printer;
transmitting an electronic file of the pattern layer into the UV inkjet printer; spraying a layer of UV-curable ink on the rear surface using the UV inkjet printer according to the electronic file of the pattern layer, and
curing the layer of UV ink to form the pattern layer.

13. The method of claim 12, wherein before the step of forming the pattern layer further comprises step of forming a transparent bonding layer on the rear surface, and the pattern layer is formed on the bonding layer.

14. The method of claim 13, wherein after the step of forming the pattern layer on the bonding layer, further comprising a step of forming a hard coating layer on the pattern layer via the UV inkjet printer.

15. The method of claim 14, wherein the pattern layer is a 3D image and defines a plurality of pattern gaps therein, and the coating layer is filled into the pattern gaps.

16. The method of claim 14, wherein the hard coating layer is made of acrylic, titanium dioxide and additives, the coating layer is mixed at a predetermined proportion under room temperature.

17. The method of claim 16, wherein the additive comprises a dispersing agent, a defoaming agent, a photosensitizer and a light stabilizer.

18. The method of claim 17, wherein the predetermined proportion is a weight ratio of the acrylic, titanium dioxide, and additives, and the weight ratio between the acrylic, titanium dioxide, and additive is respectively about 65%˜75%, 15˜20%, 5˜15%.

19. The method of claim 13, wherein the front surface is a polished surface, and the rear surface is a matted surface.

20. A double-surfaced visualization glass photograph, comprising:
a transparent base comprising a front surface and a rear surface opposite to the front surface; and a pattern layer formed on the rear surface; wherein the pattern layer is a UV ink layer and is a fogged surface.
